(19) United States
(12) Patent Application Publication
(10) Pub. No.: US 2003/0138629 A1
(43) Pub. Date: Jul. 24, 2003

(54) Textile fabric for use as a gas burner membrane

(76) Inventor: Gabriel Dewaegheneire, Zwevegem (BE)

Correspondence Address: FOLEY AND LARDNER, SUITE 500, 3000 K STREET NW, WASHINGTON, DC, 20007, US

(21) Appl. No.: 10/257,863

(22) PCT Filed: Apr. 12, 2001
(86) PCT No.: PCT/EP01/04197

(30) Foreign Application Priority Data
Apr. 17, 2000 (EP) 00201383.7
Apr. 17, 2000 (EP) 00201384.5
Apr. 17, 2000 (EP) 00201385.2
Apr. 17, 2000 (EP) 00201386.0

(51) Int. Cl. B32B 27/00; B32B 9/00; B32B 15/00; D02G 3/00; D04H 1/00; D02G 3/36; D07B 1/06

(52) U.S. Cl. 428/396; 428/365; 428/375; 428/377; 428/379; 428/378; 428/389; 428/392; 428/394; 57/217

(57) ABSTRACT

A yarn (21) comprising polymer or natural fibers (25) and one or more consolidated machined metal fiber (22) bundles is provided. The yarn is characterized in that the consolidated machined metal fiber bundles (22) are substantially surrounded by the polymer or natural fibers (25). Further the use of a textile fabric out of these yarns as a gas burner membrane is described.

### FIELD OF THE INVENTION

The invention relates to a textile fabric comprising consolidated machined metal fiber bundles, and a gas burner membrane, making use of such a fabric.

### BACKGROUND OF THE INVENTION

From FR2668176, a yarn bound with a spiral-wound synthetic filament is known.

From WO97/04152, a method is known to provide machined metal fibers. These machined metal fibers are consolidated to a consolidated metal fiber bundle and used to provide a textile fabric, e.g. by knitting. The fabric is then to be used as a gas burner membrane.

### SUMMARY OF THE INVENTION

It is an object of the invention to provide a yarn, comprising such machined metal fiber bundles. Each bundle is consolidated by wrapping a relatively fine spun or filament yarn around a bundle of machined metal fibers. This fine spun or filament yarn is hereafter referred to by “binding agent”. The yarns as subject of the invention further comprise polymer or natural fibers, substantially surrounding the consolidated machined metal fiber bundles. Possibly, the yarn further comprises ceramic fibers or ceramic fiber yarns or bundles.

It is an object of the invention to provide a textile fabric comprising such yarns. The term textile fabric refers to a fabric, provided by any known textile transformation process, e.g. weaving, warp and weft knitting, braiding, knotting or tufting.

Further it is an object of the invention to provide a method for manufacturing a gas burner membrane, comprising a textile fabric as subject of the invention.

The term “machined metal fibers” is to be understood as fibers, obtained by a cutting operation such as metallic wool (e.g. steel wool) or fibers obtained by the process of applicant as described in WO97/04152.

A gas burner membrane comprising consolidated machined metal fiber bundles is known from WO97/04152 from the applicant. However, it was found that best gas burner membranes are obtained by transferring fine consolidated machined metal fiber bundles to textile fabrics in such a way that various fine consolidated machined metal fiber bundles follow the same route in the textile fabric, running essentially parallel to each other. These various fine consolidated machined metal fiber bundles act so to say as “twin bundles”.

These fine consolidated machined metal fiber bundles however have several disadvantages. The finer they are, the easier they brake under mechanical load. This means that low transformation speeds are to be used during weaving, braiding or knitting. In case the bundles have to be transformed individually, e.g. when they have to be inserted in weft direction one by one, the weaving speed is to be very low and it takes several picks to insert only one set bundles in weft direction.

Further, the finer the bundles, the larger the risk on consolidated machined metal fiber bundles being broken due to local weaknesses of the bundle, too large fiber loss or too much fibers being pulled out partially due to the contact of the bundle surface with machine elements. These outstanding fibers may also cause problems during further transformation, since they tend to hook to each other.

When ceramic fibers are used to provide textile fabrics, it is known that transforming ceramic fibers or ceramic fiber yarns or bundles into a textile fabric, has several problems. Ceramic fibers tend to break very easily during textile operations such as e.g. weaving or knitting. This leads to relatively “hairy” fabrics with a lot of ceramic fibers, being broken and pointing away from the fabric surface. Similar as for metal fibers, the transformation speed is to be reduced drastically when using ceramic fiber yarns or ceramic fibers.

To avoid above mentioned problems, and to increase the productivity of the textile transformation, a yarn as subject of the invention comprise one or more consolidated machined metal fiber bundles. These consolidated machined metal fiber bundles usually have metrical number (hereafter abbreviated as Nm) between 0.5 and 5, more preferably between 0.5 and 3.5. The equivalent diameter of the metal fibers are usually between 10 and 150 μm, but preferably between 25 and 50 μm, e.g. 25 μm, 30 μm or 35 μm. The metal fibers can be copper, brass, titanium, aluminum, various types of stainless steel, nickel alloys and other specific types of steel containing, for example, chromium, aluminum and/or nickel and 0.05 to 0.3% by weight of yttrium, cerium, lanthanum, hafnium or titanium. The latter steels are very resistant to high temperatures and can therefor be used e.g. as burner membranes as described below.

One or more of these consolidated machined metal fiber bundles may be substantially surrounded by polymer fibers, such as polyamide fibers (PA), polyester fibers (PES), polyethylene fibers (PE), polypropylene fibers (PP), acrylic fibers such as polyacrylonitril fibers (PAN), polyvynilalcohol fibers (PVA), fibers based on cellulose or natural fibers such as e.g. cotton or wool. Preferably, the weight of polymer or natural fibers in the yarn as subject of the invention is more than 20% by weight of the yarn, most preferably even more than 30%, or even more than 40%. The surface of the yarn will substantially be provided by the polymer or natural fibers. At least 50%, but usually more than 75% of the yarn surface will be provided by polymer of natural fibers. Most preferably, more than 90% of the surface of the yarn is covered by polymer or natural fibers.

This can be done e.g. by applying the technique of core spinning. The polymer or natural fibers are spun around a core, which consists of the consolidated machined metal fiber bundles.

Another method to provide a yarn as subject of the invention is to braid various polymer or natural yarns round a core of consolidated machined metal fiber bundles.

Substantially surrounding one or more consolidated machined metal fiber bundles is preferably done by supplying these bundles, enveloped by one or more polymer or natural fiber slivers to a wrap-spinning device. A fine polymer or natural yarn is wrapped around the consolidated bundles and the slivers together.

The additional polymer or natural fibers offer to the consolidated machined metal fiber bundles more strength, so higher speed during weaving or knitting can be applied. Further, since the polymer or natural fiber layer, present at the outer surface of the yarn does not open during bending, metal fibers are prevented from being pulled out of the consolidated machined metal fiber bundles. Less to no metal fibers sticking out will be present, so less fiber loss and less problems during processing will be caused.

In case the polymer or natural fibers and binding agent is to be removed after the textile transformation process, e.g. weaving or knitting, the fibers can be removed easily and depending on their nature by burning, washing, dissolving or any other appropriate means. No polymer or natural material will be ‘trapped’ by the metal fibers, since no polymer or natural material is present inside the consolidated machined metal fiber bundles.

Moreover, in case several bundles have to be transformed in the same way at the same time, e.g. when 2 or more consolidated machined metal fiber bundles have to be inserted as a multiple weft, only one yarn, comprising the required consolidated machined metal fiber bundles, is to be inserted or used. This causes an improvement of the process output.

Alternatively, yarns comprising consolidated machined metal fiber bundles and polymer or natural fibers may comprise also ceramic fibers or ceramic fiber yarns. It was found that gas burner membranes, comprising metal fibers and ceramic fibers on its burner surface are more resistant to higher temperatures as compared to 100% metal fiber gas burner membranes. At the same time, they are more resistant to mechanical damage as compared to 100% ceramic fiber gas burner membranes. Preferably, the consolidated machined metal fiber bundles are first covered partially or fully with ceramic fibers, e.g. by wrap spinning of ceramic fiber yarns around the consolidated machined metal fiber bundle or bundles. Polymer or natural fibers are than added to this combination as described above. Alternatively, one or more consolidated machined metal fiber bundles and one or more ceramic fiber yarns are surrounded simultaneously with polymer or natural fibers by means as described above.

Different types of ceramic fibers may be used to provide the yarns present in the textile fabric for a gas burner membrane as subject of the invention. Ceramic fibers may e.g. be Al₂O₃-based fibers, further comprising SiO₂. NEXTEL®-fibers are such fibers which may be used.

Ceramic fibers based on Al₂O₃ may be used, e.g. fibers comprising 62% by weight Al₂O₃, 24% by weight SiO₂ and 14% by weight B₂O₃. Preferably however, SiO₂-based fibers are used, such as QUARTZEL® fibers from Quartz & Silice, which comprises more than 99.99% SiO₂.

When ceramic fibers are used, next to consolidated machined metal fiber bundles, the weight percentage of the surrounding natural or polymer material is preferably more than 20%. However, It was found that less polymer or natural fibers may be used to obtain good results.

A textile fabric can be provided by using yarns comprising consolidated machined metal fiber bundles, polymer or natural fibers and possibly ceramic fibers during e.g. a weaving or knitting process. The mechanical actions, applied to the yarn will not cause metal or ceramic fiber loss, since no metal fibers or possibly ceramic fibers are pulled out of the yarn surface due to contact with the textile machinery on which it is transformed. The metal fibers in the consolidated machined metal fiber bundles will essentially keep their orientation when being transformed into the fabric. This results in less fibers sticking out of the textile fabric surface in case the polymer or natural fibers and binding agent is removed. Also during the transformation process, metal or possibly ceramic fibers will not be present on the yarns' surface, so they will not cause any problems such as hooking on to metal fibers of adjacent yarns in the fabric or breaking of ceramic fibers resulting in fibers pointing out of the fabric.

Additional advantages are met when a woven or knitted fabric with a relatively open structure is to be obtained. A yarn as subject of the invention is chosen to be transformed into a woven fabric and applied in warp and weft direction, or is used for warp or weft knitting processes. After the transformation operation, the polymer or natural fibers and the binding agent may be removed in appropriate ways, leaving only the metal and possibly ceramic fibers forming a woven or knitted structure.

Depending on the weaving or knitting structure, the density in warp and/or weft direction and the volume of polymer or natural fiber used, a textile fabric with specific openings between the adjacent yarns is obtained. If necessary, additional polymer or natural yarns, not comprising consolidated machined metal fiber bundles may replace partially the yarns as subject of the invention. This to provide an even more open metal and possibly ceramic fiber structure when the polymer or natural fibers are removed.

A person skilled in the art understands that it is much easier to provide a relatively dens woven or knitted structure than an open structure. According to the invention, producing a relatively dens woven or knitted fabric comprising a yarn as subject of the invention, and removing the polymer or natural fibers of the fabric to obtain a relatively open woven or knitted fabric out of metal and possibly ceramic fibers facilitates to a large extend the production of such fabric, compared to weaving the consolidated machined metal fiber bundles and ceramic fiber yarns into such open woven or knitted structure itself.

Another benefit of a textile fabric as subject of the invention is that a yarn comprising more than one consolidated machined metal fiber bundle and possibly ceramic fiber yarns is used and when the polymer or natural fibers are removed, the consolidated machined metal fiber bundles and possibly ceramic fiber yarns are present in the textile fabric, essentially parallel to each other, and this in warp and/or weft direction. Providing such textile fabric only using the consolidated machined metal fiber bundles and ceramic fiber yarns, would cause much more problems e.g. yarn ruptures and irregular yarn distribution, and would lead to less production efficiency, especially when woven structures are to be obtained. This since each weft insert would only insert one consolidated machined metal fiber bundle, possibly combines with ceramic fibers or ceramic fiber yarns. This in contrast to the weaving of yarn as subject of the invention comprising more than one consolidated machined metal fiber bundle, and possibly ceramic fibers or ceramic fiber yarns. Each weft insertion inserts the number of consolidated machined metal fiber bundles as comprised in the yarn, as subject of the invention, possibly together with ceramic fibers or ceramic fiber yarns, also comprised in the yarn.

According to the invention, a method to manufacture a textile fabric comprising machined metal fiber bundles, comprises essentially surrounding one or more consolidated machined metal fiber bundles with polymer or natural fibers to provide a yarn. This may be done by core spinning, wrap spinning or braiding techniques. It further comprises the transformation of such yarn to a woven, braided or knitted product and eventually removing the polymer or natural fibers. Additionally, ceramic fiber yarns may be added to the consolidated machined metal fiber bundles before providing the polymer or natural fibers. Alternatively, one or more consolidated machined metal fiber bundles are first covered with ceramic fibers or ceramic fiber yarns by wrap or core spinning, before the consolidation of the consolidated machined metal fiber bundles and ceramic fibers is substantially surrounded with polymer or natural fibers.

The invention relates in particular to a specific woven or knitted structure made out of consolidated machined metal fiber bundles, of which the metal fibers are out of high temperature resistant stainless steel alloy. Such woven or knitted fabric, obtained by this method turned out to be an outstanding burner membrane in gas burners. Possibly, the gas burner membrane further comprises ceramic fibers.

In case a woven gas burner membrane is to be provided, a relatively dense woven fabric can be provided using a yarn comprising such consolidated machined metal fiber bundles and possibly ceramic fibers or ceramic fiber yarns. After weaving, the polymer or natural fibers and binding agents of the bundles are removed, e.g. by burning them. Therefor preferably well inflammable fibers are used, e.g. cellulose-based fibers. This result in a woven fabric comprising metal fibers and possibly ceramic fibers, resistant to high temperatures and having spaces between warp and weft yarns, determined by the woven structure, warp and weft density and the volume of the polymer or natural fibers. This woven fabric is than fixed on a framework in the housing of a premix gas burner in a known manner at the level of the flame. Depending on the burner characteristics, the open spaces are to be chosen, and so the weaving parameters which determines the dimensions of the spaces.

An alternative woven fabric may be provided which is characterized by the fact that the woven fabric has more than one layer of weft yarns. Warp yarns connect the different layers of weft yarns to each other. According to the present invention, warp and/or weft yarns are yarns, comprising bundles of consolidated machined metal fibers, possibly ceramic fibers, which are substantially surrounded by polymer or natural fibers.

Since this woven fabric is to be used as a gas burner membrane, a first outer surfaces faces the supply of gas-air mixture of the burner. This surface is called hereafter the gas supply surface of the gas burner membrane. The second outer surface is used as the surface of the gas burner membrane, on which the combustion action starts. This surface, also called the combustion or radiant surface is hereafter called burner surface.

The different layers of weft yarns are connected to each other with one or more warp yarns. Further some warp yarns may only be used to connect the different weft yarns in the same layer of weft yarns. Warp and weft yarns which are present at the burner surface preferably comprises heat resistant consolidated machined metal fibers and ceramic fibers, whereas yarns providing the other layers may comprise less heat resistant consolidated machined metal fiber bundles.

A gas burner membrane as subject of the invention is provided using such a woven textile fabric. The advantages of a gas burner membrane as subject of the invention over the presently known gas burner membrane, are when the burner surface is damaged or used, the danger on sudden flash-backs is minimized, if not avoided. When the burner surface is damages, e.g. by a subject which has scratched the surface, an object has dropped on the surface or the thermal resistant fibers are used, a small aperture may be observed on the surface. When such aperture is met on a presently known gas burner membrane, this aperture may easily expand since the warp and weft yarns which are damaged, e.g. broken on this spot are no longer fixed into the woven structure, causing sudden flash-backs. The woven structure of the textile fabric providing such a gas burner membrane will tend to curl upwards, away from the burner surface. When objects pass near the burner surface, the curling of the woven fabric may hinder them.

When such an aperture is met on a gas burner membrane as subject of the invention, this defect can be seen during an inspection of the burner surface, but the additional layers under the aperture will act as a barrier for the temperature to rise beyond the gas burner membrane (causing flash-backs). It will also prevent the aperture from expanding, since the warp yarns, which are also fixed in the layer or layers underneath the burner surface, hinder the expansion and curling of the fabric. Further, the layers underneath the burner surface will act as a support layer, supporting e.g. a ceramic burner surface or a metal burner surface. It is generally known that in time, metal burner surfaces loose gradually their strength since they oxidize.

Gas burner membranes as subject of the invention are also more self supporting, so the used of a supporting screen may be avoided. The used of such supporting screens does not provide the advantages of the invention, since e.g. it does not prevent the expansion from the apertures.

It was found that woven structures provided by this method and used as a gas burner membrane does not show flash backs and may offer good CO and NOx emission values during operation.

Similar results were obtained for knitted fabrics as subject of the invention.

In case different open space dimensions are required over the surface of the woven or knitted fabric, different yarns as subject of the invention and different densities may be used in different zones of the textile fabric. After removing the polymer fibers and the binding agent, a fabric is obtained, comprising different zones. Each zone of the fabric has its own openings between adjacent yarns, and each zone has its specific air permeability, both characteristics are depending upon the used density to provide the textile fabric. In case this fabric is used as a gas burner membrane, a membrane with different combustion zones is obtained.

These elements of the invention are now explained into more detail on the base of a number of embodiments of such yarns and textile fabrics.

### BRIEF DESCRIPTION OF THE DRAWINGS

The invention will now be described into more detail with reference to the accompanying drawings wherein

FIG. 1 is a radial section of a yarn as subject of the invention.

FIG. 2 is a schematic side view of a yarn as subject of the invention.

FIG. 3 is a view of a woven fabric as subject of the invention, comprising yarns as subject of the invention.

FIG. 4 is a view of another woven fabric as subject of the invention, comprising yarns as subject of the invention.

FIG. 5 is a view of a gas burner membrane as subject of the invention, based on the fabric as shown in FIG. 3.

FIG. 6 is a view of another gas burner membrane as subject of the invention.

FIG. 7a and FIG. 7b are a view of a yarn, comprising consolidated machined metal fiber bundle, ceramic fiber yarns and polymer or natural fibers, as subject of the invention.

FIG. 8 shows an alternative gas burner membrane as subject of the invention.

### DESCRIPTION OF THE PREFERRED EMBODIMENTS OF THE INVENTION

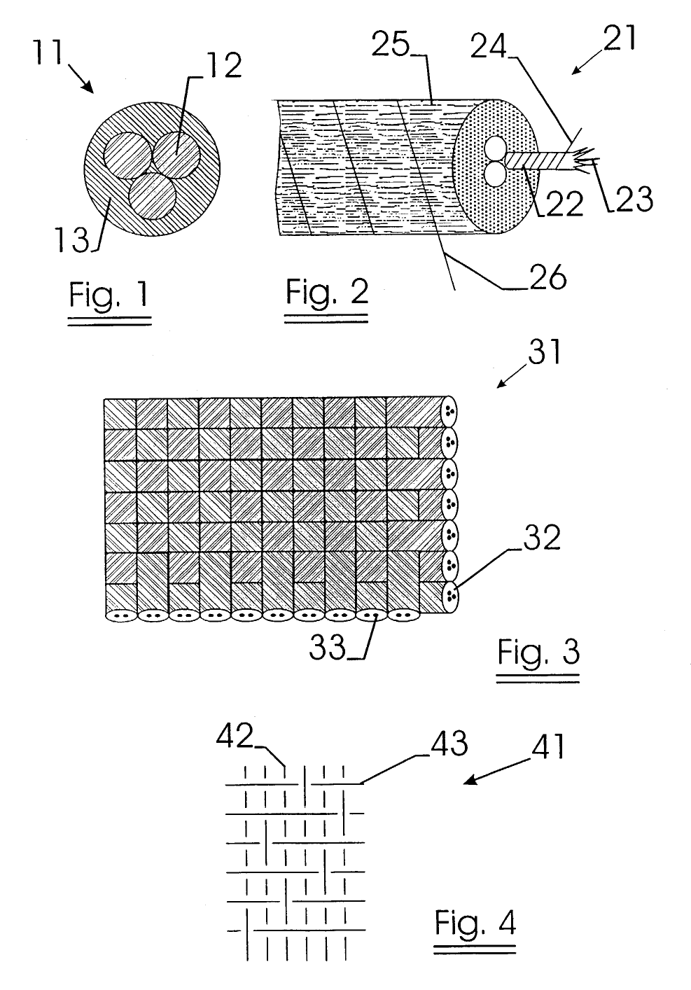

A yarn as subject of the invention is shown in FIGS. 1 and 2. A cross section of a yarn 11 is shown in FIG. 1. Three consolidated machined metal fiber bundles 12 are surrounded by a layer 13 of polymer or natural fibers. These polymer or natural fibers can be provided by core spinning round the consolidated machined metal fiber bundles, or as shown in FIG. 2, a yarn 21 may be provided by wrap spinning. Several consolidated machined metal fiber bundles 22 are used. These bundles comprise machined metal fibers 23, which are consolidated by wrapping a fine polymer or natural yarn 24 around the fibers. One or more slivers of polymer or natural fibers 25 envelop these consolidated metal fiber bundles 22. By wrapping a fine polymer or natural yarn 26 around the polymer or natural fibers 25 and the consolidated bundles 22, a yarn 21, comprising consolidated machined metal fiber bundles, surrounded by polymer or natural fibers is provided. One understands that the number of consolidated machined metal fiber bundles 22, the titer of these bundles, the nature of the polymer or natural fibers 25 and yarns 24 and 26 used and the amount of polymer or natural fibers 25 may be chosen to provide the required properties of the yarn 21.

A specific embodiment of the yarn as subject of the invention is obtained using three bundles of consolidated machined metal fibers, having a titer of 333 tex (333 gram per kilometer yarn), each bundle being wrapped with a fine PA yarn with titer 156 dtex. These consolidated machined metal fiber bundles are enveloped with acrylic fiber bundles. The yarn has a titer in total of 1660 tex, consisting of 62% by weight of machined metal fibers and 38% by weight acrylic fibers.

In the same way, two consolidated machined metal fiber bundles of 333 tex may be enveloped by acrylic fibers to provide a yarn as subject of the invention of 1420 tex, comprising 50% by weight machined metal fibers and 50% by weight acrylic fibers.

One bundle of consolidated machined metal fibers may be surrounded with acrylic fibers providing a yarn as subject of the invention having a titer of 680 tex, comprising 52% by weight machined metal fibers and 48% by weight acrylic fibers.

A woven fabric 31 as subject of the invention is shown in FIG. 3. Warp yarns 32 are yarns which comprise 3 consolidated machined metal fiber bundles as shown in FIG. 2. Weft yarns 33 are yarns identical to warp yarns, but comprising only 2 consolidated machined metal fiber bundles. Warp and weft are woven in a plan weaving structure with 2.5 warps per cm and 7.5 wefts per cm. No significant openings between warp and weft are noticed.

An alternative fabric 41 is provided using the weaving as shown in FIG. 4. The warp yarns 42 comprise 2 consolidated machined metal fiber bundles, where the weft yarns 43 comprise 2 consolidated machined metal fiber bundles. Fifty-seven warp yarns per ten cm and forty-five weft yarns per ten cm further characterize the fabric.

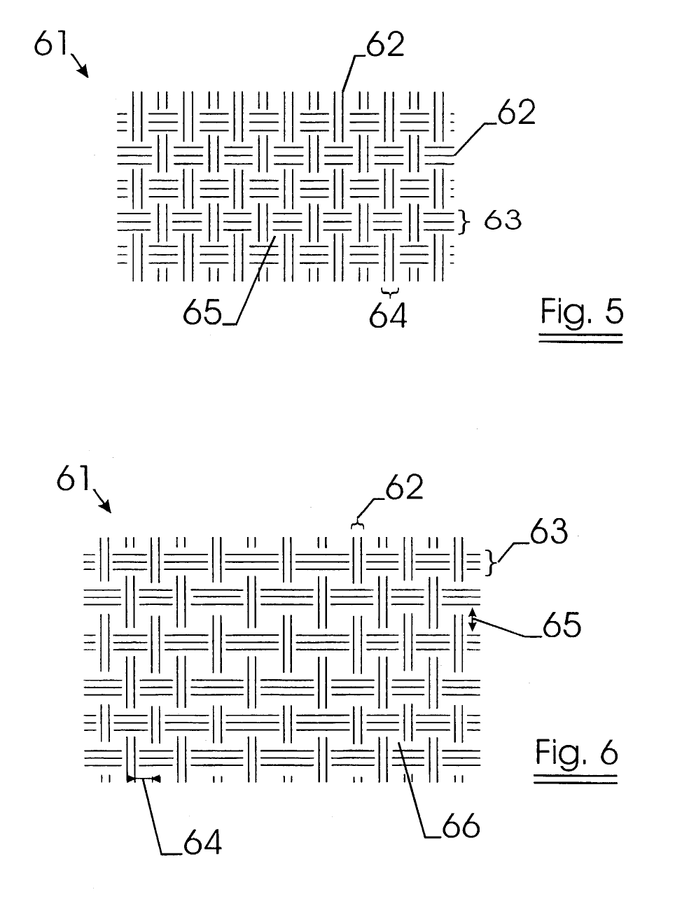

This fabric 31 or 41 may be used as a gas burner membrane, after the polymer or natural fibers are removed by burning them. After burning, a fabric 51 as shown in FIG. 5 is obtained using the fabric 31. As can be seen, only the metal fiber bundles 52 remain.

In warp direction, the three metal fiber bundles 52 run essentially parallel to each other, forming warp groups 53. In weft direction, two metal fiber bundles 52 run essentially parallel to each other forming weft groups 54. Warp and weft groups 53 and 54 remain in the fabric, and the original plain weaving structure is to be noticed.

Between the warp and weft groups 53 and 54, there are openings 55. When the fabric is used as a gas burner membrane, gas essentially flows through the openings 55, where the gas ignites. Depending on the size of the openings and the weaving structure used, more or less gas is allowed to flow through the membrane under certain pressure.

Different sizes of the openings can be introduced in the fabric by varying the weaving structure and/or the weaving density in warp and weft direction.

As shown in FIG. 6, woven fabric 6 may comprise different zones, each zone having different sizes of the openings 66. The fabric is provided by applying several warp groups 62 and weft groups 63. The weaving density in warp direction, determined locally by distance 64, is changed over the surface of the fabric.

The weaving density in weft direction, determined locally by distance 65, is also changed over the surface of the fabric. Doing so, the opening 66 is determined by distanced 64 and 65, present at a certain area in the fabric.

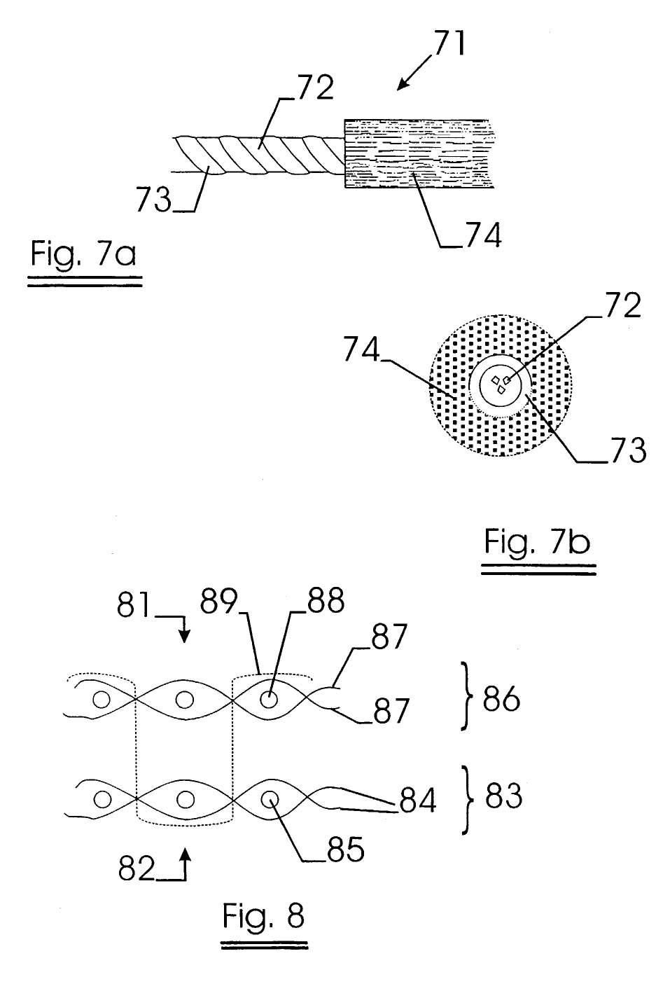

An alternative yarn, used to provide a textile fabric as subject of the invention, is shown in FIG. 7a and FIG. 7b (which is a radial section of the yarn of FIG. 7a). A yarn 71 comprises a consolidated machined metal fiber bundle 72, which is spirally wound by wrap spinning techniques with a ceramic fiber yarn 73. This combination was than substantially surrounded by polymer or natural fibers 74, also by wrap spinning techniques.

A specific embodiment of the yarn as subject of the invention is obtained using a bundle of consolidated machined metal fibers, having a titer of 333 tex (333 gram per kilometer yarn), and being wrapped with a fine PA yarn with titer 156 dtex. This consolidated machined metal fiber bundle is than wrapped with a ceramic fiber yarn, preferably a ceramic yarn being a ply of two Quartzel®-yarns, each Quartzel® yarn being a plied yarn of two times 120 filaments of 9 μm diameter each. The ceramic yarn thus comprises approximately 480 filaments, providing a ceramic yarn of 66 Tex. This ceramic fiber wrapped consolidated machined metal fiber bundle is than wrapped with polyamid fibers, to provide a yarn which has an outer layer, being substantially provided by this polyamid fibers. The content of such yarn is approximately 63% by weight of metal fiber, 29% by weight of ceramic (Qurtzel®-) fiber and 8% by weight of polyamid fiber.

An embodiment of a woven gas burner membrane as subject of the invention, comprising more than one layer of weft yarns is shown in FIG. 8.

FIG. 8 shows a cross section of a woven fabric 80, to be used as a gas burner membrane as subject of the invention. A burner surface 81 and a gas supply surface 82 is provided. The fabric 10 comprises two layers of weft yarns. First weft yarn layer 83 is provided by weaving warp yarns 84 and weft yarn 85. A second weft yarn layer 86 is provided by weaving warp yarns 87 and weft yarns 88. Both layers are connected to each other with warp yarns 89.

An embodiment is obtained by using metal fiber yarns for both layers 83 and 86. Yarns 84 and 85 are metal fiber yarns, comprising AISI 316L stainless steel fibers. Yarns 87, 88 and 89 comprise Fecralloy® consolidated machined metal fiber bundles. Preferably a Fecralloy® consolidated machined metal fiber bundle with metrical number 3/1 Nm=333 Tex) is used, comprising Fecralloy® metal fibers with equivalent diameter of 35 μm or 22 μm. Such bundles are substantially surrounded with viscose fibers.

Alternatively, ceramic fiber yarns may be comprised in yarns 88. Preferably a Quartzel® filament yarn with metrical number 30 Nm (=33 Tex) is used, comprising fibers with diameter of 9 μm. Most preferably, this yarn is a double plied yarn, comprising two single yarns of metrical number 59 Nm (=17 Tex).

1. A yarn comprising polymer or natural fibers and a machined metal fiber bundle, said bundle being consolidated with a binding agent, characterized in that said consolidated machined metal fiber bundle is substantially surrounded by said polymer or natural fibers.

2. A yarn according to claim 1, wherein said yarn comprises more than one machined metal fiber bundle.

3. A yarn according to claim 1 or 2, characterized in that volume of said polymer or natural fibers is more than 20% of the total fiber volume.

4. A yarn according to claim 1 to 3, further comprising ceramic fibers.

5. A yarn according to claim 4, said ceramic fibers are wrapped around said consolidated machined metal fiber bundle.

6. A textile fabric comprising a yarn according to claim 1 to 5.

7. A textile fabric according to claim 6, said textile fabric is a woven fabric.

8. A textile fabric according to claim 6 or 7, wherein said textile fabric comprise at least two zones for which the air permeability of at least one of said zones is different from the other of said zones.

9. A textile fabric as in claim 1 to 8, said textile fabric being woven, said woven fabric comprising more than one layer of weft yarns.

10. A method for manufacturing a textile fabric comprising the steps of providing machined metal fiber bundles, said bundles being consolidated by means of a binding agent; surrounding one or more of said consolidated bundles with polymer or natural fibers to obtain a yarn and processing of said yarn into a textile fabric by means of weaving, braiding or knitting.

11. A method according to claim 10, further comprising the step of providing ceramic fiber yarn around said machined metal fiber bundle.

12. A method for manufacturing a textile fabric as in claim 10 or 11, wherein said textile fabric comprise at least two zones for which the air permeability of at least one of said zones is different from the other of said zones

13. A method according to claim 10 to 12, comprising the additional step of removing said binding agent and said polymer or natural fibers from said textile fabric.

14. A method according to claim 10 to 13, characterized in that said surrounding one or more of said consolidated bundles with said polymer or natural fibers is obtained by wrap spinning.

15. The use of a textile fabric according to claims 6 to 9 as a gas burner membrane.

16. The use of a textile fabric, obtainable by the method as in claim 10 to 14, as a gas burner membrane.

17. A method for manufacturing a gas burner membrane comprising the steps of providing machined metal fiber bundles, said bundles being consolidated by means of a binding agent; surrounding one or more of said consolidated bundles with polymer or natural fibers to obtain yarn; processing of said yarn into a textile fabric by means of weaving, braiding or knitting; removing said binding agent and said polymer or natural fibers from said textile fabric.

18. A method according to claim 17, further comprising the step of providing ceramic fiber yarn around said machined metal fiber bundle.

19. A method for manufacturing a gas burner membrane as in claim 17 or 18, wherein said textile fabric comprise at least two zones for which the air permeability of at least one of said zones is different from the other of said zones.
